(19) United States
(12) Patent Application Publication
(10) Pub. No.: US 2023/0415906 A1
(43) Pub. Date: Dec. 28, 2023

(54) ELECTRIC PROPULSION UNIT COMPRISING AT LEAST TWO INDEPENDENT SUPPORTS, AIRCRAFT COMPRISING AT LEAST ONE SUCH ELECTRIC PROPULSION UNIT

(71) Applicant: Airbus Operations SAS, TOULOUSE (FR)

(72) Inventors: Kotaro FUKASAKU, TOULOUSE (FR); Rémi AMARGIER, TOULOUSE (FR); Lionel CZAPLA, TOULOUSE (FR); Nicolas JOLIVET, TOULOUSE (FR); Pascal POME, TOULOUSE (FR)

(21) Appl. No.: 18/339,032

(22) Filed: Jun. 21, 2023

(30) Foreign Application Priority Data
Jun. 27, 2022 (FR) 2206360

(51) Int. Cl. B64D 27/26; B64D 27/24; H02K 5/24

(52) U.S. Cl. CPC B64D 27/26; B64D 27/24; H02K 5/24; B64D 2027/262

(57) ABSTRACT

An aircraft propulsion assembly including at least one first support that supports an electric propulsion system, at least one first attachment configured to connect the first support and a support structure of an aircraft, at least one second support distinct from and dissociated from the first support supporting a source of electrical energy configured to supply the electric propulsion system with electrical energy, as well as at least one second attachment configured to connect the second support and the support structure. An aircraft may include at least one such propulsion assembly. Given that the second support is distinct from and dissociated from the first support system, vibrations generated by the electric propulsion system are not transmitted to the source of electrical energy.

### CROSS-REFERENCES TO RELATED APPLICATIONS

This application claims the benefit of the French patent application No. 2206360 filed on Jun. 27, 2022, the entire disclosures of which are incorporated herein by way of reference.

### FIELD OF THE INVENTION

The present application relates to an electric propulsion assembly comprising at least two independent supports and to an aircraft including at least one such electric propulsion assembly.

### BACKGROUND OF THE INVENTION

In an embodiment that can be seen in FIG. 1, an aircraft 10 comprises a fuselage 12, wings 14 connected to the fuselage 12 and propulsion assemblies 16 connected to the wings 14 by pylons 18 and disposed on either side of the fuselage 12.

As depicted in FIGS. 2 and 3 each propulsion assembly 16 comprises at least one electric motor 20, a propeller 22 having a rotation axis A22 and a coupling system 24, such as a gearbox or a reducer for example, connecting the electric motor 20 and the propeller 22. In one configuration the propulsion assembly 16 also comprises at least one source of electrical energy 26 including fuel cells 26.1, at least one hydrogen tank 26.2 configured to supply the fuel cells 26.1 with hydrogen and possibly a cooling system 26.3 for regulating the temperature of the fuel cells 26.1.

In the embodiment that can be seen in FIGS. 2 and 3 the propulsion assembly 16 comprises a single support 28 to which are connected, by means of connecting systems 30, the electric motor 20, the propeller 22, the coupling system 24, the fuel cells 26.1, the hydrogen tank 26.2 and the cooling system 26.3, together with at least one wing attachment 32 configured to connect the support 28 to one of the wings 14.

In operation the electric motor 20, the propeller 22 and the coupling system 24 generate vibrations at a high level. The fuel cells 26.1 and the hydrogen tank 26.2 being sensitive to vibrations, the support 28 and/or some connecting systems 30 are designed in such a manner as to limit the propagation of vibrations in the direction of the fuel cells 26.1. These adaptations of the support 28 and/or of some connecting systems 30 take up space in each propulsion assembly 16. Moreover, they give rise to an increase in the weight of each propulsion assembly 16 and, in the end, the energy consumption of the aircraft.

The present invention aims to remedy some or all of the disadvantages of the prior art.

### SUMMARY OF THE INVENTION

To this end the invention has for object an aircraft propulsion assembly including at least one electric propulsion system as well as at least one source of electrical energy configured to supply the electric propulsion system with electrical energy, the propulsion assembly having mutually orthogonal first, second and third directions, the first direction being substantially parallel to a direction of thrust of the electric propulsion system, the second direction being substantially horizontal.

According to the invention the propulsion assembly comprises at least one first support supporting the electric propulsion system, at least one first attachment configured to connect the first support and a support structure of an aircraft, at least one second support distinct from and dissociated from the first support supporting the source of electrical energy as well as at least one second attachment configured to connect the second support and the support structure.

Providing two distinct and dissociated supports enables them to be simplified and there to be no need to design them in such a manner that they limit the propagation of vibrations, which contributes to reducing the overall size of the first and second supports and the overall weight of the propulsion assembly.

The invention also has for an object an aircraft comprising at least one support structure and at least one propulsion assembly having the above features connected to the support structure.

In accordance with another feature, at least one element from the first attachment and the second attachment comprises shock absorbing or antivibration elements to filter vibrations in the first, second and third directions.

In accordance with another feature, an element comprising the first attachment and/or the second attachment comprises at least one pivoting connection or linear connection for filtering vibrations in at least one first orientation from the first, second and third directions and at least one second element different from the first element from the first attachment and the second attachment comprises at least one pivoting connection or linear connection for filtering vibrations in at least one second orientation different from the first orientation from the first, second and third directions, the first and second elements being configured to filter vibrations in all of the first, second and third directions.

In accordance with another feature, the first attachment comprises a pivoting sliding connection having a pivot axis parallel to the third direction and/or a linear connection allowing movement in translation in the second direction and pivoting in the third direction to filter the vibrations in at least the third direction.

In accordance with another feature, the second attachment comprises at least one linear connection allowing movement in translation in the first direction and/or at least one link connected at each of its ends by pivoting connections having pivot axes parallel to the second direction to filter vibrations in at least the first direction.

In accordance with another feature, the support structure has a first stiffness in the first direction and a second stiffness in the third direction different from the first stiffness.

### BRIEF DESCRIPTION OF THE DRAWINGS

Other features and advantages will emerge from the following description of the invention given by way of example only with reference to the appended drawings, in which:

FIG. 1 is a schematic representation in perspective of an aircraft,

FIG. 2 is a schematic representation of a propulsion assembly without its nacelle depicting an embodiment of the prior art,

FIG. 3 is a side view of a propulsion assembly without its nacelle depicting an embodiment of the prior art,

FIG. 4 is a schematic representation of a propulsion assembly without its nacelle depicting an embodiment of the invention,

FIG. 5 is a side view of a propulsion assembly without its nacelle depicting an embodiment of the invention,

FIG. 6 is a schematic representation in perspective of the first and second supports connected by attachments to a support structure depicting an embodiment of the invention.

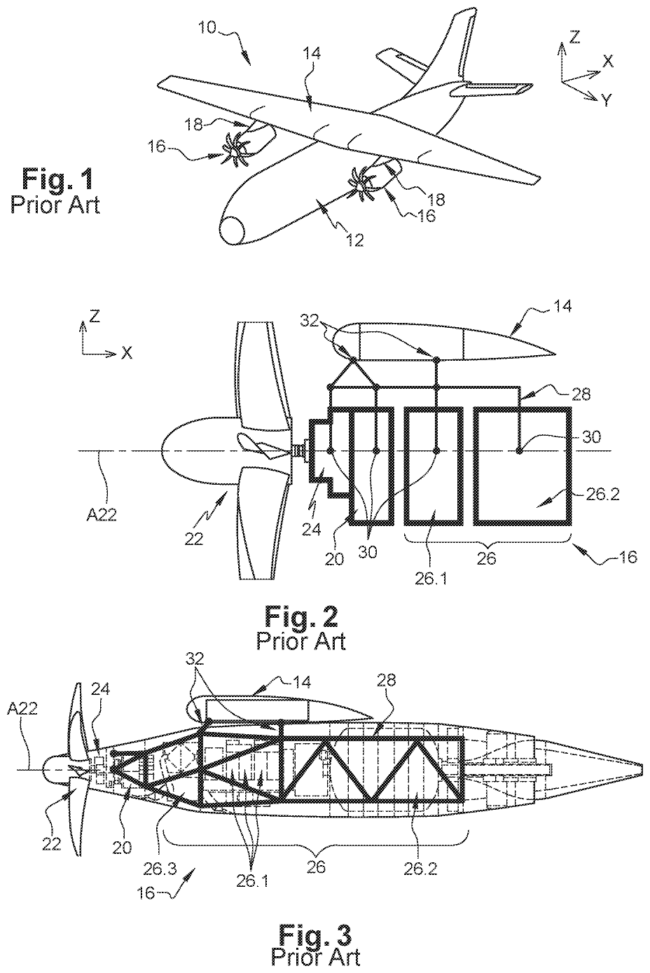

### DETAILED DESCRIPTION OF THE PREFERRED EMBODIMENTS

In known manner, an aircraft comprises a fuselage, wings connected to the fuselage that extend on either side of the fuselage and propulsion assemblies 40 positioned under and connected to the wings. Of course, the invention is not limited to this embodiment. Regardless of the embodiment, an aircraft comprises at least one propulsion assembly 40 connected to a support structure 42 that may be the structure of a wing, the structure of the fuselage or any other structure of the aircraft.

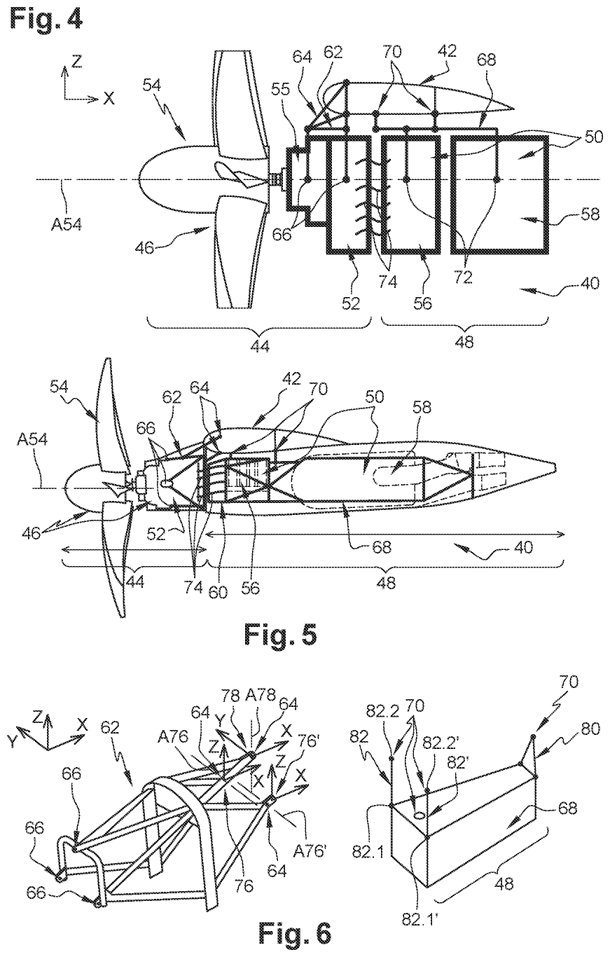

In an embodiment that can be seen in FIGS. 4 and 5, an aircraft propulsion assembly 40 comprises a first part 44 including electric propulsion system 46 and a second part 48 including at least one source of electrical energy 50 configured to supply the electric propulsion system 46 with electrical energy. Additionally, the propulsion assembly 40 comprises a secondary structure in the form of a fairing to optimize the aerodynamic properties of the propulsion assembly 40. This secondary structure is not represented in FIG. 4 and is represented as if by transparency in FIG. 5.

In one embodiment, the electric propulsion system 46 comprises at least one electric motor 52, a propeller 54 having a rotation axis A54 and a coupling system 55 such as a gearbox or a reducer, for example, connecting the electric motor 52 and the propeller 54. The electric propulsion system 46 generates thrust oriented in a thrust direction substantially parallel to the rotation axis A54 of the propeller 54.

In one embodiment, the source of electrical energy 50 comprises at least one fuel cell 56 configured to supply the electric motor or motors 52 with electrical energy.

In one configuration, the source of electrical energy 50 also comprises at least one hydrogen tank 58 configured to supply the fuel cells 56 with hydrogen as well as a cooling system 60 configured to cool the source of electrical energy 50, in particular the fuel cells 56. Of course, the invention is not limited to this configuration. Thus, the hydrogen tank 58 could be positioned in the fuselage of the aircraft.

The electric motor 52, the propeller 54, the coupling system 55, the fuel cells 56, the hydrogen tank 58 and the cooling system 60 are not described in more detail because they may be identical to those of the prior art.

The first part 44 comprises at least one first support 62 supporting the electric propulsion system 46 and at least one first attachment 64 configured to connect the first support 62 and the support structure 42. In one configuration the electric propulsion system 46 is connected to the first support 62 by at least one connection 66.

The second part 48 comprises at least one second support 68 distinct from and dissociated from the first support 62 supporting the source of electrical energy 50 as well as at least one second attachment 70 configured to connect the second support 68 and the support structure 42. In one configuration, the source of electrical energy 50 is connected to the second support 68 by at least one second connection 72.

Given that the second support 68 is distinct from and dissociated from the first support 62 the vibrations generated by the electric propulsion system 46, in particular by the electric motor 52 and the propeller 54, are not transmitted to the source of electrical energy 50, in particular to the fuel cells 56, in contrast to the prior art which provides a single support to which are connected the electric propulsion system 46 and the source of electrical energy 50.

Providing two distinct and dissociated supports 62, 68 makes it possible to simplify them and for there to be no need to design them in such a manner that they limit the propagation of vibrations, which contributes to reducing the overall size of the first and second supports 62, 68 and the overall weight of the propulsion assembly 40.

In one embodiment, the first support 62 is a metal or composite material structure. It may be produced by any method of manufacture such as machining, additive manufacturing, welding or other method. For example, the first support 62 is a welded truss structure.

Like the first support 62, the second support 68 is a metal or composite material structure. It may be produced by any method of manufacture such as machining, additive manufacture, welding or other method. For example, the first support 62 is a welded truss structure.

Of course, the invention is not limited to these embodiments of the first and second supports 62, 68.

In one arrangement, the first part 44 is positioned in front of the second part 48. Alternatively, the first part 44 is positioned behind the second part 48.

In one embodiment, the propulsion assembly 40 comprises at least one flexible element 74 such as an electric cable for example for electrically connecting the first and second parts 44, 48. The propulsion assembly 40 may comprise a flexible element 74 in the form of at least one pipe with a flexible section such as a bellows, for example, for conveying a fluid between the first and second parts 44, 48. Because of the flexible nature of these flexible elements 74 they do not transmit vibrations between the first and second parts 44, 48.

At least one element from the first attachment 64, the second attachment 70 and the support structure 42 is configured to filter vibrations in first, second and third mutually orthogonal directions X, Y, Z in order to limit the propagation of vibratory phenomena between the first and second supports 62, 68, the first direction X being substantially parallel to the direction of thrust of the electric propulsion system 46, the second direction being substantially horizontal.

In one configuration, one element from the first attachment 64, the second attachment 70 and the support structure 42 is configured to filter vibrations in the first, second and third mutually orthogonal directions X, Y, Z.

In another configuration, at least one element from the first attachment 64, the second attachment 70 and the support structure 42 is configured to filter vibrations in at least a first orientation from the first, second and third mutually orthogonal directions X, Y, Z. Additionally, at least one second element different from the first element from the first attachment 64, the second attachment 70 and the support structure 42 is configured to filter vibrations in at least a second orientation different from the first orientation from the first, second and third mutually orthogonal directions X, Y, Z, the first and second elements being configured to filter vibrations in all the first, second and third mutually orthogonal directions X, Y, Z.

In an embodiment that can be seen in FIG. 6, the first attachment 64 is configured to filter vibrations in at least the third direction Z and preferably in the second and third directions Y and Z. Additionally, the second attachment 70 is configured to filter vibrations in at least the first direction X and preferably in the first and second directions X and Y.

In this embodiment the first attachment 64 comprises a pivoting sliding connection 78 having a pivot axis A78 parallel to the third direction Z and/or a linear connection allowing movement in translation in the second direction Y and pivoting in the third direction Z to filter vibrations in at least the third direction Z. In one configuration the first attachment 64 comprises two pivoting sliding connections 76, 76′ connecting the first part 44 and the support structure 42 and having substantially coaxial pivot axes A76, A76′ parallel to the second direction Y and a pivoting sliding connection 78 having a pivot axis A78 substantially parallel to the third direction Z. Alternatively the pivoting sliding connection 78 may be replaced by a linear connection allowing movement in translation in the second direction Y and pivoting in the third direction Z.

The second attachment 70 comprises at least one linear connection 80 allowing movement in translation in the first direction X and pivoting in the second direction Y and/or at least one link connected at each of its ends by pivoting connections having a pivot axis parallel to the second direction Y to filter the vibrations in at least the first direction X. In one configuration the second attachment 70 comprises a second linear connection 80 allowing movement in translation in the first direction X and pivoting in the second direction Y as well as two links 82, 82′ each having a first end 82.1, 82.1′ connected to the second part 48 by a pivoting sliding connection having a pivot axis parallel to the second direction Y and a second end 82.2, 82.2′ connected to the support structure 42 having a pivot axis parallel to the second direction Y.

Alternatively or additionally, the first and second attachments 64, 70 comprise shock absorbing or antivibration elements, as sold under the product name “Silentbloc” for example, and/or the support structure 42 has a first stiffness in the first direction X and a second stiffness in the third direction Z different from the first stiffness.

In one embodiment, the first and second connections 66, 72 comprise shock absorbing or antivibration elements, as sold under the product name “Silentbloc,” for example, to limit the propagation of vibratory phenomena between the elements connected by each of the first or second connections 66, 72.

Of course, the invention is not limited to this embodiment for filtering vibrations by means of the first and second attachments 64, 70 and the support structure 42. Regardless of the embodiment the first attachment 64, the second attachment 70 and the support structure 42 are designed in such a manner as to limit the propagation of vibrations and to prevent the transfer of vibrations between the first and second parts 44, 48 via the support structure 42.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft propulsion assembly comprising:
at least one electric propulsion system,
at least one source of electrical energy configured to supply the electric propulsion system with electrical energy, the propulsion assembly having mutually orthogonal first, second and third directions,
the first direction being substantially parallel to a direction of thrust of the electric propulsion system,
the second direction being substantially horizontal,
at least one first support supporting the electric propulsion system,
at least one first attachment configured to connect the first support and a support structure of an aircraft,
at least one second support distinct from and dissociated from the first support supporting the source of electrical energy, and
at least one second attachment configured to connect the second support and the support structure.

2. An aircraft comprising at least one support structure and at least one propulsion assembly according to claim 1 connected to the support structure.

3. The aircraft as claimed in claim 2, wherein at least one element from the first attachment and the second attachment comprises shock absorbing or antivibration elements to filter vibrations in the first, second and third directions.

4. The aircraft as claimed in claim 2,
wherein at least one first element from the first attachment and the second attachment comprises at least one pivoting connection or linear connection for filtering vibrations in at least one first orientation from the first, second and third directions, and
wherein at least one second element different from the first element from the first attachment and the second attachment comprises at least one pivoting connection or linear connection for filtering vibrations in at least one second orientation different from the first orientation from the first, second and third directions, the first and second elements being configured to filter vibrations in all of the first, second and third directions.

5. The aircraft as claimed in claim 4, wherein the first attachment comprises a pivoting sliding connection having a pivot axis parallel to the third direction, a linear connection allowing movement in translation in the second direction and pivoting in the third direction to filter the vibrations in at least the third direction, or both the pivoting sliding connection and the linear connection.

6. The aircraft as claimed in claim 5, wherein the first attachment comprises two pivoting sliding connections connecting the first support and the support structure and having substantially coaxial pivot axes parallel to the second direction, as well as a pivoting sliding connection having a pivot axis substantially parallel to the third direction.

7. The aircraft as claimed in claim 4, wherein the second attachment comprises at least one linear connection allowing movement in translation in the first direction, or a link connected at each of its ends by pivoting connections having pivot axes parallel to the second direction to filter vibrations in at least the first direction, or both the linear connection and the link connections.

8. The aircraft as claimed in claim 7, wherein the second attachment comprises a second linear connection allowing movement in translation in the first direction, as well as two links each having a first end connected to the second support by a pivoting sliding connection having a pivot axis parallel to the second direction and a second end connected to the support structure having a pivot axis parallel to the second direction.

9. The aircraft as claimed in claim 3, wherein the support structure has a first stiffness in the first direction and a second stiffness in the third direction different from the first stiffness.
